(19) United States
(12) Patent Application Publication
(10) Pub. No.: US 2007/0263178 A1
(43) Pub. Date: Nov. 15, 2007

(54) Projection system and control method of the same

(75) Inventor: Jong-soo Lee, Cheonan-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/698,032

(22) Filed: Jan. 26, 2007

(30) Foreign Application Priority Data
May 15, 2006 (KR) 10-2006-0043339

(51) Int. Cl. G03B 21/20

(52) U.S. Cl. 353/85

(57) ABSTRACT

A projection system and a control method of the same, in which the projection system includes: a light source that emits light; a light gathering system that gathers the light emitted from the light source; a display device that generates an image by using the light gathered by the light gathering system; a projection lens system that enlarges and projects the image generated by the display device; a screen that displays the projected image thereon; a power level adjusting part that adjusts a level of the power supplied to the light source; a power source that supplies power to the power level adjusting part; and a power-supplying controller that determines a type of the power source and controls the power level adjusting part to power having a level that differs based on the determined type of the power source.

### CROSS-REFERENCE TO RELATED APPLICATIONS

This application claims the benefit of Korean Patent Application No. 10-2006-0043339, filed on May 15, 2006, in the Korean Intellectual Property Office, the disclosure of which is incorporated herein by reference.

### BACKGROUND OF THE INVENTION

1. Field of the Invention

Systems and methods consistent with the present invention relate to a projection system and a control method of the same, and more particularly, to a projection system to which power can be supplied from a plurality of different power sources, and a control method of the same.

2. Description of the Related Art

Generally, a projection system enlarges and projects an image generated by a display device onto a screen in order to provide an enlarged image. Herein, the projection system includes a light source that emits light, a light gathering system that gathers the emitted light, the display device that generates an image by using the light provided from the light gathering system, and a projection lens system that projects the image generated by the display device.

The projection system may be classified as a front projection type or a rear projection type based on a direction of enlarging and projecting of the image. For example, the front projection type system may include a projector provided in front of a screen that projects an image onto the screen. The rear projection type system may include a projection television (TV) provided rear of a screen that projects an image onto the screen.

A portable, compact projection system has been recently developed. The portable projection system is not connected to a commercial alternating current (AC) power source. Instead, a battery supplies a power that differs from commercial AC power to the portable projection system. However, there may be a problem in that the power supplied from the battery cannot normally drive a light source because the light source needs power having a constant maximum level regardless of a type and a capacity of the supplied power.

### SUMMARY OF THE INVENTION

Exemplary embodiments of the present invention overcome the above disadvantages and other disadvantages not described above. Also, the present invention is not required to overcome the disadvantages described above, and an exemplary embodiments of the present invention may not overcome any of the problems described above.

The present invention provides a projection system and a control method of the same, which can use a power source efficiently by adjusting a level of the power supplied to a light source based on a type and/or capacity of power supplied from the power source.

According to an aspect of the present invention, there is provided a projection system including: a light source to emit light; a light gathering system to gather the light emitted from the light source; a display device to generate an image by using the light gathered by the light gathering system; a projection lens system to enlarge and project the image generated by the display device; a screen to display the projected image thereon; a power level adjusting part to adjust a level of the power supplied to the light source; a power source to supply power to the power level adjusting part; and a power-supplying controller to determine a type of the power source, and to control the power level adjusting part to supply power having a different level depending on the determined type of the power source.

The power source may be an AC adapter or a battery.

The projecting system may include: a first port to be connected to the AC adapter, and a second port to be connected to the battery, wherein the power-supplying controller determines whether the AC adapter or the battery is connected to the first port or the second port, respectively.

The power supplying controller may control the power level adjusting part to supply power having the maximum level adjusted depending on the type of the power supplied from the power source.

The power supplying controller may control the power level adjusting part to supply power having a maximum level adjusted depending on the capacity of power supplied from the power source.

The projecting system may include a maximum output setting part to set up the maximum level.

The image projected from the projection lens system to be displayed on the screen may have a smaller diagonal size than 20 inches.

The image projected from the projection lens system to be displayed on the screen may have a larger diagonal size than 20 inches.

According to another aspect of the present invention, there is provided a control method of a projecting system including a light source to emit light; a light gathering system to gather the light emitted from the light source; a display device to generate an image by using the light gathered by the light gathering system; a projection lens system to enlarge and project the image generated by the display device; a screen to display the projected image thereon; and a power source to supply power to the light source. The control method includes: determining a type of the power source; and adjusting a level of the power supplied to the light source depending on the type of the power source.

The adjusting the level of the power supplied to the light source may include adjusting a maximum level of the power supplied to the light source depending on the type of the power source.

The method may further include determining capacity of power supplied from the power source after determining the type of the power source.

The adjusting of the level of the power supplied to the light source may include adjusting a maximum level of the power supplied to the light source depending on the capacity of power supplied from the power source.

### BRIEF DESCRIPTION OF THE DRAWINGS

The above and/or other aspects of the present invention will become apparent and more readily appreciated from the following description of the exemplary embodiments, taken in conjunction with the accompanying drawings of which:

FIG. 1 is a control block diagram of a projection system according to an exemplary embodiment of the present invention;

FIG. 2 is a control flowchart of the projection system according to an exemplary embodiment of the present invention; and

FIG. 3 is a control flowchart of the projection system according to another exemplary embodiment of the present invention.

### DETAILED DESCRIPTION OF THE EXEMPLARY EMBODIMENTS

Reference will now be made in detail to the exemplary embodiments of the present invention, examples of which are illustrated in the accompanying drawings, wherein like reference numerals refer to like elements throughout.

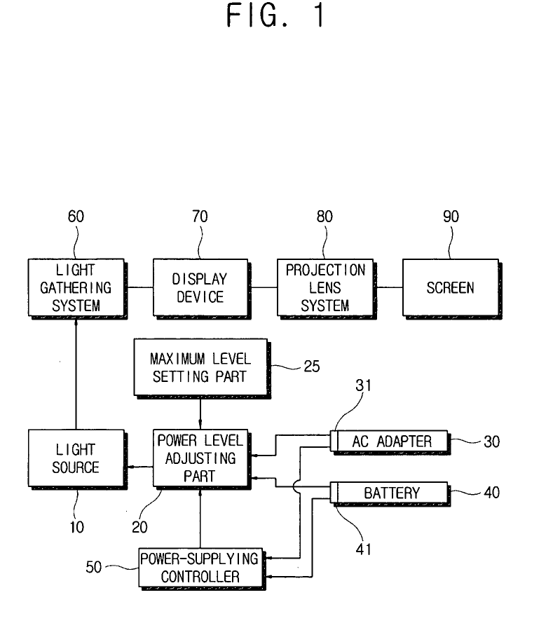

FIG. 1 is a control block diagram of a projection system according to an exemplary embodiment of the present invention.

As illustrated, the projection system according to the exemplary embodiment of the present invention includes a light source 10, a light gathering system 60, a display device 70, a projection lens system 80, and a screen 90. The projection system further includes power sources 30 and 40 that supplies power, a power level adjusting part 20, a maximum level setting part 25, and a power-supplying controller 50.

The light source 10 may mainly employ an arc lamp that emits white light. Herein, a ballast may be provided to drive the arc lamp. A color wheel may be provided in front of the light source 10 to separate the emitted white light into red (R) color light, green (G) color light, and blue (B) color light. A driving motor may be also provided to drive the color wheel at a high speed.

Alternatively, a plasma display panel (PDP) may be employed as a light source. At this time, in the PDP, ultraviolet rays generated from discharge gas collide with fluorescent substances, thereby emitting light.

The light source 10 may also include an LED (light emitting diode) or an LASER (Light amplification by Stimulated Emission of radiation) instead of the arc lamp.

The light gathering system 60 uniformly gathers the separated R, G, and B color light. The gathered light is provided to the display device 70.

The display device 70 may mainly employ a cathode ray tube (CRT) device, a liquid crystal display (LCD) device, and/or a liquid crystal on silicon (LCOS) device. Recently, a digital micro-mirror device (DMD) having a plurality of micro-mirrors has been employed as a display device, which is developed using micro electro mechanical system (MEMS) technology.

As discussed above, the display device 70 according to the exemplary embodiment of the present invention may use the DMD. The DMD includes the plural micro-mirrors arranged in two dimensions, the micro-mirrors forming pixels. The micro-mirrors are driven so that they lean at a first angle or at a second angle based on the electrostatic effect of memory devices. This changes an angle of reflecting light, thereby controlling the DMD. The DMD has faster response time than other type display devises such as the LCD device and the LCOS device, and accordingly the DMD can smoothly replay moving images without cutting-off.

The projection lens system 80 includes a plurality of lenses that enlarge and project the image generated by the display device 70 to the screen 90. The screen 90 may have a rectangular shape. The size of the image displayed on the screen 90 may be adjusted according to a user selection. For example, the diagonal size of the projected image may be less than or greater than 20 inches.

The power sources 30 and 40 that supply power to the light source 10 include an AC adapter 30 and/or a battery 40. For example, when a user uses the projection system while carrying it, the battery 40 is normally employed as the power source. At this time, it is essential that enough power is supplied to the light source 10 when a user uses the projection system while carrying it. The AC adapter 30 converts commercial AC power into direct current power so that the power is suitable for the projection system. The battery 40 generally supplies direct current power to the projection system.

The projection system includes a first port 31 that is connectable to the AC adapter 30, and a second port 41 that is connectable to the battery 40. The power-supplying controller 50 may determine the type of the power source 30, 40 based on whether the first port 31 or the second port 41 has been connected to the power source. Alternatively, the power-supplying controller 50 may determine the type of the power source based on whether a power type of the power source 30 or 40 is AC current power or direct current (DC) power.

The power-level adjusting part 20 is provided between the power source 30, 40 and the light source 10. The power-level adjusting part 20 adjusts the level of the power provided from the power sources 30 and 40 and provides the power to the light source 10. The brightness of light emitted from the light source 10 is adjusted based on the level of the power supplied from the power level adjusting part 20. Conventionally, the supplied power level is the same when the power is supplied from the AC adapter 30 and when the power is supplied from the battery. Accordingly, when the power is supplied from the AC adapter 30, there is little problem because the AC adapter 30 stably provides the power. However, when the power is supplied from the battery 40, there is a problem because the battery 40 may not stably provide the power and additionally the capacity of the power supplied from the battery 40 is gradually reduced as the battery 40 is discharged. At this time, if the level of the power supplied to the light source 10 is not adjusted, the light source 10 may not emit light. Thus, the power-supplying controller 50 controls the power level adjusting part 20 so that it supplies power having a level that differs based on a type of the power source and/or a capacity of the power supplied from the power source 30 or 40 to the light source 10. In this exemplary embodiment, the power level adjusting part 20 adjusts the level of power supplied to the light source 10. The power level adjusting part 20 adjusts the power level to a maximum level, that is a level of power required for maximum brightness, thereby automatically adjusting the power to a level lower than a maximum level that can be provided by the power source.

Further, the power-supplying controller 50 determines the type of the power source 30 or 40 that has currently supplied power to the light source 10, and controls the power-level adjusting part 20 so that it supplies power having a different level depending on the determined type of the power source 30 or 40 to the light source 10. At this time, preset maximum level values corresponding to the power source 30 and 40 are stored in the power-supplying controller 50. These maximum levels are levels that differ based on the type and the capacity of the determined power source 30 or 40. In this exemplary embodiment, when the AC adapter 30 is connected to the first port 31 so that AC power is supplied, the power-supplying part 50 transmits information, including a preset first maximum level value corresponding to the AC adapter 30, to the power level adjusting part 20. When the battery 40 is connected to the second port 41, the power-supplying part 50 transmits information, including a preset second maximum level value corresponding to the battery 40, to the power level adjusting part 20. Here, the second maximum level value may be lower than the first maximum level value. The information may include, in addition to the first maximum level value or the second maximum level value, various maximum level values based on power capacity, etc. To use the power sources more efficiently, the power-supplying controller 50 possibly can include more information, including maximum level values corresponding to determined types of the power sources.

Alternatively, a user may set up the first maximum level value, the second maximum value, and/or the like through the maximum level setting part 25. Using the maximum level setting part 25, the maximum level values may be preset in the power-supplying controller 50. Also, a user may select the first maximum level value, the second maximum value, and/or the like, without regard to the power sources 30 and 40 but instead based on an environment in which the projection system is used. A user may change the maximum level values as desired. Herein, the maximum level setting part 25 may further include a user interface part that allows the user to set the maximum level values.

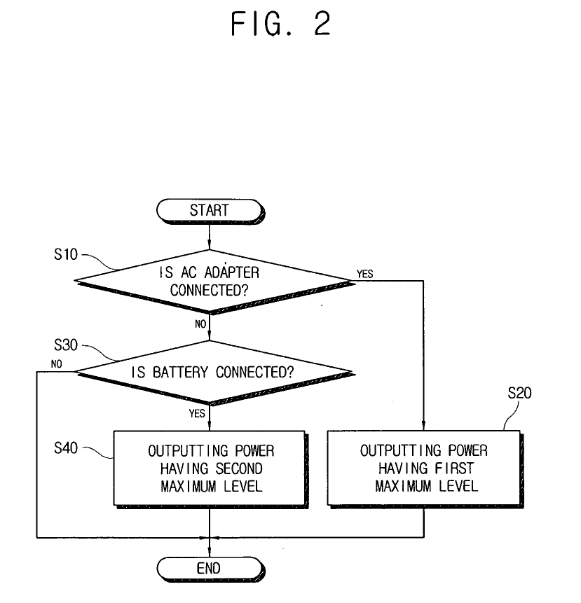

FIG. 2 is a control flowchart of the projection system according to an exemplary embodiment of the present invention.

First, when power provided from the power source 30 or 40 is supplied to the light source 10, the power-supplying part 50 determines a type of the power source 30 or 40. Further, the power-supplying part 50 determines whether the AC adapter 30 is connected to the first port 31 (S10). When the AC adapter 30 is connected to the first port 31, the power-supplying part 50 transmits information including the preset first maximum level value corresponding to the AC adapter 30 to the power-level adjusting part 20, and controls the power-level adjusting part 20 to output power having the first maximum level to the light source 10 (S20).

Conversely, when the AC adapter 30 is not connected to the first port 31, the power-supplying part 50 determines whether the battery 40 is connected to the second port 41 (S30). When the battery 40 is connected to the second port 41, the power-supplying part 50 transmits information including the preset second maximum level value corresponding to the battery 40 to the power-level adjusting part 20, and controls the power-level adjusting part 20 so that it outputs power having the second maximum level to the light source 10 (S40). Here, the second maximum level value according to the exemplary embodiment of the present invention is lower than the first maximum level value.

As described above, the power-level adjusting part 20 can output power at each of the maximum levels preset by the power-supplying part 50. However, the power-level adjusting part 20 is not limited to this exemplary embodiment. Alternatively, a user may set up the maximum level values through the maximum level setting part 25. To determine the type of the power source 30 or 40, the power-supplying part 50 may determine whether the power source 30 or 40 is connected to the second port 41 prior to determining whether it is connected to the first port 31. Alternatively, the power-supplying part 50 may determine the type of the power source 30 or 40 by using various methods instead of the above-mentioned method.

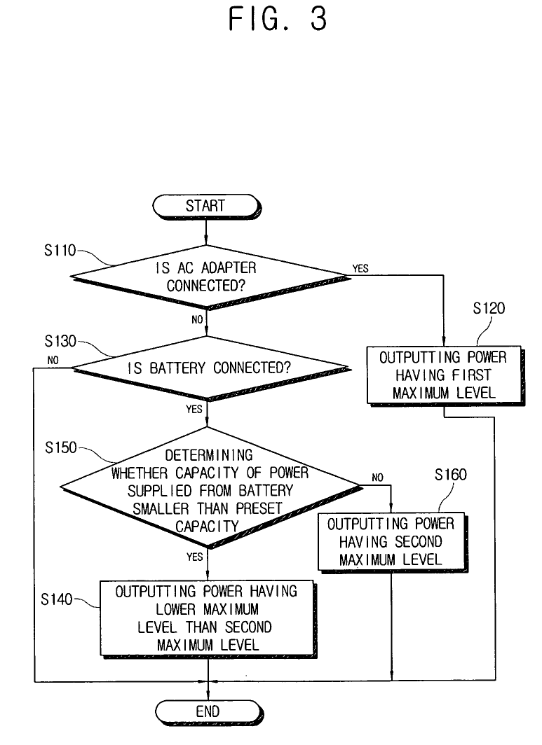

FIG. 3 is a control flowchart of the projection system according to another exemplary embodiment of the present invention. Operations 110, 120 and 130 are the same as operations 10, 20 and 30, respectively in the previous exemplary embodiment. In operation 110, the power-supplying part 50 determines whether the AC adapter 30 is connected to the first port 31. In operation 120, the power level adjusting part 20 outputs the power having the first maximum level to the light source 10 in the same way shown in FIG. 2. In operation 130, the power-supplying part 50 determines whether the battery 40 is connected to the second port 41 when the AC adapter 30 is not connected to the first port 31.

When the battery 40 is connected to the second port 41, the power-supplying part 50 determines whether capacity of power supplied from the battery is smaller than preset capacity (S150). Here, the preset capacity may be the power capacity that is enough to output power at a preset maximum level to the light source 10.

For example, when the power capacity is reduced because the battery 40 has been used for a long time, the maximum level of the power supplied to the light source 10 should be adjusted so that the remaining power can be used for a longer time. Accordingly, when the capacity of the power supplied from the battery is smaller than the preset capacity, the power-supplying controller 50 controls the power level adjusting part 20 so that it supplies power having a lower maximum level, which is less than the second maximum level, to the light source 10 (S140).

Conversely, when the capacity of the power supplied from the battery power is larger than the preset capacity, the power-supplying controller 50 controls the power level adjusting part 20 so that it supplies power having the second maximum level (S160).

As shown in FIGS. 2 and 3, power having the maximum levels is supplied to the light source 10. Alternatively, power having various levels, which are based on the type of the power source and the capacity of the power supplied from the power sources 30 and 40, may be supplied to the light source 10.

As apparent from the above description, according to the exemplary embodiment of the present invention, there are provided a projection system and a control method of the same, which can use a power source efficiently by adjusting a level of the power thereof according to a type of the power source and/or a capacity of power supplied from the power source.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A projection system comprising:
a light source that emits light;
a light gathering system that gathers the light emitted from the light source;
a display device that generates an image using the light gathered by the light gathering system;
a projection lens system that enlarges and projects the image generated by the display device;
a screen that displays the projected image thereon;
a power level adjusting part that adjusts a level of power supplied to the light source;
a power source that supplies the power to the power level adjusting part; and
a power-supplying controller that determines a type of the power source, and controls the power level adjusting part so that it supplies power having a level that differs based on the determined type of the power source.

2. The projecting system according to claim 1, wherein the power source comprises an alternating current (AC) adapter or a battery.

3. The projecting system according to claim 2, further comprising:
a first port that is connectable to the AC adapter, and
a second port that is connectable to the battery, and
wherein the power-supplying controller determines whether the AC adapter is connected to the first port and whether the battery is connected to the second port.

4. The projecting system according to claim 1, wherein the power supplying controller controls the power level adjusting part to supply power having a maximum level that is adjusted based on the type of the power source.

5. The method according to claim 1, wherein the power supplying controller determines a capacity of the power supplied from the power source and controls the power level adjusting part to supply power having a level that differs based on the capacity of the power supplied from the power source.

6. The projecting system according to claim 1, wherein the power supplying controller controls the power level adjusting part to supply power having a maximum level that is adjusted based on the capacity of the power supplied from the power source.

7. The projecting system according to claim 6, further comprising:
a maximum output setting part that sets the maximum level.

8. The projecting system according to claim 4, further comprising:
a maximum output setting part that sets the maximum level.

9. The projecting system according to claim 1, wherein the image projected from the projection lens system to be displayed on the screen has a diagonal size that is less than 20 inches.

10. The projecting system according to claim 1, wherein the size of the image projected from the projection lens system and displayed on the screen has a diagonal size that is greater than 20 inches.

11. A control method of a projecting system comprising a light source that emits light; a light gathering system that gathers the light emitted from the light source; a display device that generates an image by using the light gathered by the light gathering system; a projection lens system that enlarges and projects the image generated by the display device; a screen that displays the projected image thereon; and a power source that supplies power to the light source, the method comprising:
determining a type of the power source; and
adjusting a level of the power supplied to the light source based on the type of the power source.

12. The method according to claim 11, wherein the adjusting the level of the power supplied to the light source comprises adjusting a maximum level of the power supplied to the light source based on the type of the power source.

13. The method according to claim 11, further comprising:
determining a capacity of power supplied from the power source after determining the type of the power source.

14. The method according to claim 12, wherein the adjusting the level of the power supplied to the light source comprises adjusting a maximum level of the power supplied to the light source based on a capacity of the power supplied from the power source.
